(19) United States
(12) Patent Application Publication
(10) Pub. No.: US 2018/0176859 A1
(43) Pub. Date: Jun. 21, 2018

(54) System and Method for Selecting a Wireless Access Point

(71) Applicant: Sharp Laboratories of America, Inc., Camas, WA (US)

(72) Inventors: Darin Haines, Washougal, WA (US); William Vojak, Battle Ground, WA (US); Gary Lin Gaebel, Vancouver, WA (US); John C. Thomas, Portland, OR (US)

(21) Appl. No.: 15/379,582

(22) Filed: Dec. 15, 2016

(51) Int. Cl. H04W 48/20; H04W 4/02

(52) U.S. Cl. CPC H04W 48/20; H04W 4/02

(57) ABSTRACT

A system and method are provided for a mobile unit to select a wireless access point. The method provides a mobile unit with a wireless transponder and a location determination device, such as a global positioning satellite (GPS) receiver. A local features database is stored in the memory, cross-referencing a plurality of wireless access points (APs) to corresponding geographic locations. In response to receiving location information, a wireless AP selection application determines the geographic position of the mobile unit, accesses the local features database, and selects the wireless AP associated with the geographic position of the mobile unit. Finally, the wireless AP selection application directs the transponder to communicate with the selected wireless AP. In one aspect, the local features database divides a geographic region into sub-regions, with a corresponding wireless AP assigned to each sub-region. For example, each sub-region may assigned to the closest wireless AP.

### BACKGROUND OF THE INVENTION

### 1. Field of the Invention

This invention generally relates to mobile wireless communications and, more particularly, to a system and method for selecting a wireless access point.

### 2. Description of the Related Art

The cost and complexity of the equipment needed to communicate between a wirelessly capable vehicle and a multiplicity of telecommunication access points is substantial. Existing solutions measure the signal from all available communication access points; selecting only the best signal (strongest amplitude, most favorable signal to noise ratio, lowest latency, etc.). Existing solutions are optimized for situations where the surrounding terrain and the locations of access points are unknown.

It would be advantageous if available communication access points could be simply and surely discovered based upon predetermined knowledge of the terrain surrounding a vehicle and the location of potential access points.

### SUMMARY OF THE INVENTION

Disclosed herein are a system and method that permit a vehicle or mobile unit to more simply identify potential wireless access points or base stations. This system has application to a smart, autonomous vehicle that has an independent means to identify its absolute position at all times. This requirement may be fulfilled by an on-board global positioning satellite (GPS) unit or by any other locating means. Using this position information, the vehicle can identify the most appropriate telecommunication access point to communicate with by consulting a pre-defined, on-board lookup table. It is not necessarily important that the identified access point be the closest, or that it provides the strongest signal strength. But as long as the identified access point provides an adequate signal strength, the connection between the vehicle and the base station is not lost. This approach changes the problem from searching for the strongest available communication signal to one of automatically connecting with an adequate communication signal.

The coordinates that define a region with a preferred given telecommunication access point can be determined empirically by measuring the communication error rates at various locations around the terrain of interest, when communicating with each access point. Alternatively (and much more simply) the operator can tile the terrain of interest with regions in the vicinity of, and corresponding to each of the telecommunication access points. The only run-time decision required of the vehicle is “I am at location X, switch to communication access point Y”. The equipment required to implement this solution is simple and inexpensive. The run-time requirements are minimal and effective. But for obvious reasons, this solution is best suited to situations where the surrounding terrain and the locations of access points are all well known.

Accordingly, a method is provided for a mobile unit to select a wireless access point. The method provides a mobile unit with a wireless transponder, a location determination device, such as a global positioning satellite (GPS) receiver, a non-transitory memory, and a processor. A local features database is stored in the memory, cross-referencing a plurality of wireless access points (APs) to corresponding geographic locations. A wireless AP selection application is also stored in the memory and enabled as a sequence of processor executable instructions. In response to receiving location information from the location determination device, the wireless AP selection application determines the geographic position of the mobile unit, accesses the local features database, and selects the wireless AP associated with the geographic position of the mobile unit. Finally, the wireless AP selection application directs the transponder to communicate with the selected wireless AP.

In one aspect, the local features database divides a geographic region into sub-regions, with a corresponding wireless AP assigned to each sub-region. For example, each sub-region may be assigned to the closest wireless AP. Otherwise, each sub-region may be assigned to a corresponding wireless AP on the basis of a wireless AP figure of merit, such as transmitter power of the wireless AP, signal strength of the received wireless AP signal, bit error rate, signal-to-noise ratio, latency, or the directionality of the wireless AP's antenna.

In another aspect, if the geographic region includes a known communications or geographic obstacle, then wireless APs are assigned to each sub-region on the basis minimizing the impact of the obstacle. If the wireless APs are not enabled at all times, the local features database may assign wireless APs to each sub-region on the basis of a known wireless AP enablement schedule. Further, if the local features database assigns a primary wireless AP and a secondary wireless AP to a corresponding sub-region, the wireless AP selection application may select the secondary wireless AP in the event that communications with the primary wireless AP fail.

Additional details of the above-described method and a mobile unit system for selecting a wireless access point are provided below.

### BRIEF DESCRIPTION OF THE DRAWINGS

FIG. 1 is a schematic block diagram of a mobile unit system for selecting a wireless access point.

FIG. 2 is a diagram of an exemplary local features database.

FIG. 3 is a plan view depicting an exemplary geographic region where an autonomous robotic device is patrolling.

FIG. 4 is a plan view depicting a second exemplary patrolled region.

FIG. 5 is a plan view depicting a third exemplary patrolled region.

FIG. 6 is a flowchart illustrating a wireless access point selection method.

FIG. 7 is a flowchart illustrating a method for a mobile unit to select a wireless access point.

### DETAILED DESCRIPTION

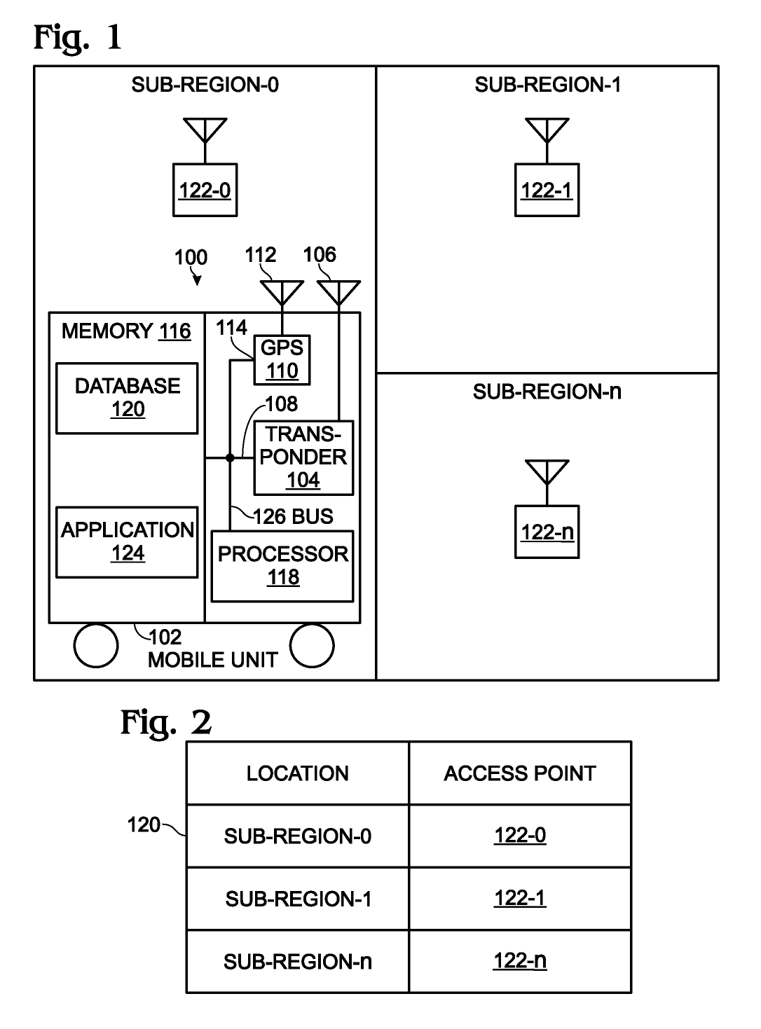

FIG. 1 is a schematic block diagram of a mobile unit system for selecting a wireless access point. The system 100 of mobile unit 102 comprises a wireless transponder 104 with an antenna 106 and an interface 108. As used herein, a “transponder is understood to be a full-duplex wireless communications device, capable of initiating and receiving analog, digital, and HD video type communications, such as a radio, Wi-Fi device, or a cellular telephone to name a few examples. A location determination device 110 also has an antenna 112 and an interface 114. The location determination unit 110 is most practically a global positioning satellite (GPS) receiver, but could potentially also be a long range navigation (LORAN) receiver, or a receiver that determines position based upon the triangulation of multiple transmitted signals, and is not limited to any means of position determination. The system 100 further comprises a non-transitory memory 116, a processor 118, and a local features database 120 stored in the memory 116 that cross-references a plurality of wireless access points (APs) to corresponding geographic locations (sub-regions). Shown are wireless APs 122-0 through 122-n, where n is an integer not limited to any particular value greater than 1. As used herein, a wireless AP is understood to be a fixed-position base station capable of wireless communications with the mobile unit 102. The communication format may be a telecommunications, Wi-Fi, or Bluetooth format, to name a few examples. The system 100 is not limited to any particular type of wireless format.

A wireless AP selection application 124 is stored in the memory 116 and is enabled as a sequence of processor executable instructions. The wireless AP selection application 124 determines the geographic position of the mobile unit in response to receiving location information from the location determination device 110, accesses the local features database 120, selects a wireless AP associated with the geographic position of the mobile unit 102, and directs the transponder 104 to communicate with the selected wireless AP. In one aspect, the transponder 104 is capable of operating at a plurality of channels, and the wireless AP selection application 124 directs the transponder to operate at a channel associated with the selected wireless AP. As used herein, a “channel” may be a frequency, a spreading code, format, packet header ID, or any other means of distinguishing between individual wireless APs.

The combination of components in the above-described system 100 may be described as a type of computer and so employ a bus 126 or other communication mechanism for communicating information between the processor 118, memory 116, and the interfaces 108 and 114, and for processing information. The memory 116 may also include a main memory, such as a random access memory (RAM) or other dynamic storage device, coupled to the bus 126 for storing information and instructions to be executed by processor 118. These memories may also be referred to as a computer-readable medium. The execution of the sequences of instructions contained in a computer-readable medium may cause a processor to perform some of the steps associated with selecting a wireless AP. Alternately, the simplicity of selecting a wireless AP through the use of a look-up table (LUT) may permit the selection process to be performed in hardware or using combinational logic. The practical implementation of such a computer system or logic system would be well known to one with skill in the art.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, or any other magnetic medium, a CD-ROM, any other optical medium, a RAM, a PROM, an EPROM, a FLASH-EPROM, any other memory chip or cartridge, or any other medium from which a computer can read. In some aspects, the system 100 may be enabled using a handheld device such as a personal digital assistant (PDA), cell phone, smart phone, tablet, or notebook computer. Further, although the system 100 is depicted as being co-located within the mobile unit 102, components of the system may be remotely located from the mobile unit, and accessed via a wireless communications link (not shown).

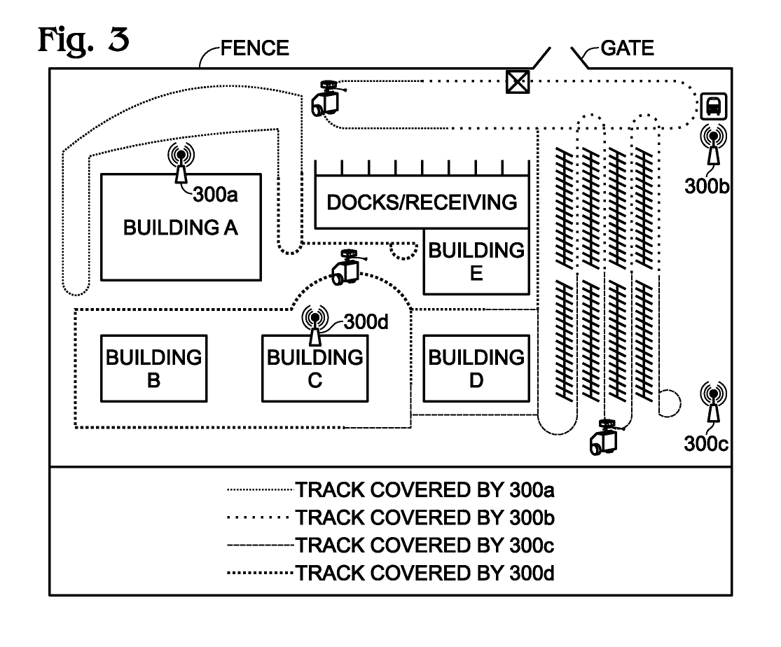

FIG. 2 is a diagram of an exemplary local features database. In its simplest form, the local features database 120 is a simple LUT that identifies a wireless AP in response to the wireless AP selection application inputting a geographic position. In this sense, the “selection” process is simply the receipt of the wireless AP from the LUT. That is, the local features database divides a geographic region into sub-regions 0 through n, with corresponding wireless APs (122-0 through 122-n) respectively assigned to the sub-regions. In one aspect, each sub-region assigned to the closest wireless AP. In a slightly more complicated variation, each sub-region is assigned to a corresponding wireless AP on the basis of a wireless AP figure of merit, such as, but not limited to, the transmitter power of the wireless AP, the signal strength of the received wireless AP signal, bit error rate, signal-to-noise ratio, latency, the directionality of the wireless AP's antenna, or the directionality of the mobile unit's transponder antenna.

In another aspect, as shown in examples below, the geographic region defined in the local features database 120 includes one or more communication obstacles, with a wireless AP assigned to each sub-region, or different areas inside a sub-region, on the basis minimizing the impact of the communication obstacles. The communication obstacle may be geographic, a building or mountain for example, or an area known to having interfering signals. In a related variation, the local features database may assign a plurality of wireless APs assigned to a particular sub-region impacted by a communications obstacle, and the wireless AP selection application acts to compare the mobile unit geographic position to the communication obstacle, whose existence may be supplied by the local features database, and select the wireless AP least obscured by the communication obstacle.

In one aspect, the wireless APs may not be enabled on all days or at all times of the day. Then, upon inputting time and date information, the local features database assigns a wireless AP to each sub-region on the basis of a known wireless AP enablement schedule. Alternatively, the local features database may supply a plurality of wireless AP options upon receiving the mobile unit geographic position input, and the wireless AP selection application acts to determine which of the supplied wireless APs is enabled.

In yet another aspect, the local features database may assign a primary wireless AP and a secondary wireless AP to a particular (e.g., first) sub-region, and the wireless AP selection application, after determining that the mobile unit is located in the first sub-region, selects the secondary wireless AP in the event that communications with the primary wireless AP fail.

One example of the above-described system is a Security Autonomous Vehicle (or SAV). Its job may be to patrol a region of property and to report all unwanted events or activity to a security guard, who is sitting at a remote base station. The SAV is equipped with a computing device, a memory storage means, and a GPS. The computing device is capable of reading the GPS to determine the absolute and instantaneous position of the SAV.

For the sake of this discussion, the region to be patrolled is a large, rectangular, employee automobile parking lot, and there is one Wi-Fi access point at each corner of this parking lot. The parking lot is small enough that from any point within the parking lot, the SAV can communicate successfully with at least one Wi-Fi access point. Wi-Fi equipment on board the SAV can be programmatically switched from one communication channel or access point to another.

This local features database can be implemented by loading a table of GPS coordinates into the computing device, where the GPS coordinates correspond to four quadrants of the parking lot. Each row of the table corresponds to one quadrant and identifies the Wi-Fi access point closest to that quadrant. When the on-board GPS indicates that the SAV has moved from one quadrant of the parking lot to another, the computing device signals the communication equipment to switch to the Wi-Fi access point corresponding to the new quadrant.

The simple example above presumes a rectangular region of interest and four symmetrically placed Wi-Fi access points, each with identical signal strength. More generally of course, the region of interest may be non-rectangular and the Wi-Fi access points may be unsymmetrically placed or of unequal signal strength. The rows of the lookup table may refer to non-quadrant, non-rectangular regions and the telecommunication means may be something other than Wi-Fi.

The example above suggests a vehicle with a single radio that is commanded to tune to the radio as necessary based on GPS coordinates within a given region. Alternatively, a vehicle could have a plurality of radios wherein each radio stays tuned to the frequency of a corresponding AP. In this manner, the transition from one access point to the next access point is engaged with minimal downtime during the switch-over.

It may be the case that the wireless access points employ directional rather than spherical antennas. Similarly, the wireless communication equipment on the SAV may employ one or more directional antennas. In such cases, the aforementioned lookup table may contain additional rows of information regarding the directionality of the access points as well as an indication of how best to orient a directional antenna on the SAV to achieve optimum communications.

It may be the case that a particular geofenced area contains one or more obstacles that block wireless communication with the optimum wireless access point(s) for that region. In such cases, the aforementioned lookup table may contain additional rows of information specifying one or more alternate access points to use when the SAV is in such a portion of the geofenced region.

It may also be the case that a particular geofenced area contains one or more wireless access points that are disabled during specific times during the day, or disabled on particular days. In such cases, the aforementioned lookup table may contain additional rows of information specifying one or more alternate access points to use when the SAV is in the geofenced region during a time period when all of the preferred access points are disabled.

Similarly, it may be the case that a particular geofenced area contains one or more preferred wireless access points that have failed to operate, perhaps due to a power failure. In such cases, the aforementioned lookup table may contain additional rows of information specifying one or more alternate access points to use when the SAV is in the geofenced region.

FIG. 3 is a plan view depicting an exemplary geographic region where an autonomous robotic device is patrolling. The area is covered by four wireless network nodes (300a through 300d) and regions of travel assigned to the wireless network nodes. The area is mapped to show where along the patrol routes a wireless receiver/transmitter can maximize the signal quality coming from the various wireless network nodes. As the autonomous robotic device (or multiple autonomous robotic devices) move around the area, at any given point the signal strength of one wireless network node will be superior (or preferred) to the other three wireless nodes. This preference is mapped to the route that the autonomous robotic device(s) travels. So for every given point along the route, the autonomous robotic device knows which wireless network node it should be communicating with. This allows for a simple and low cost alternative to having additional hardware dedicated to analyzing signal strengths on a continuous basis.

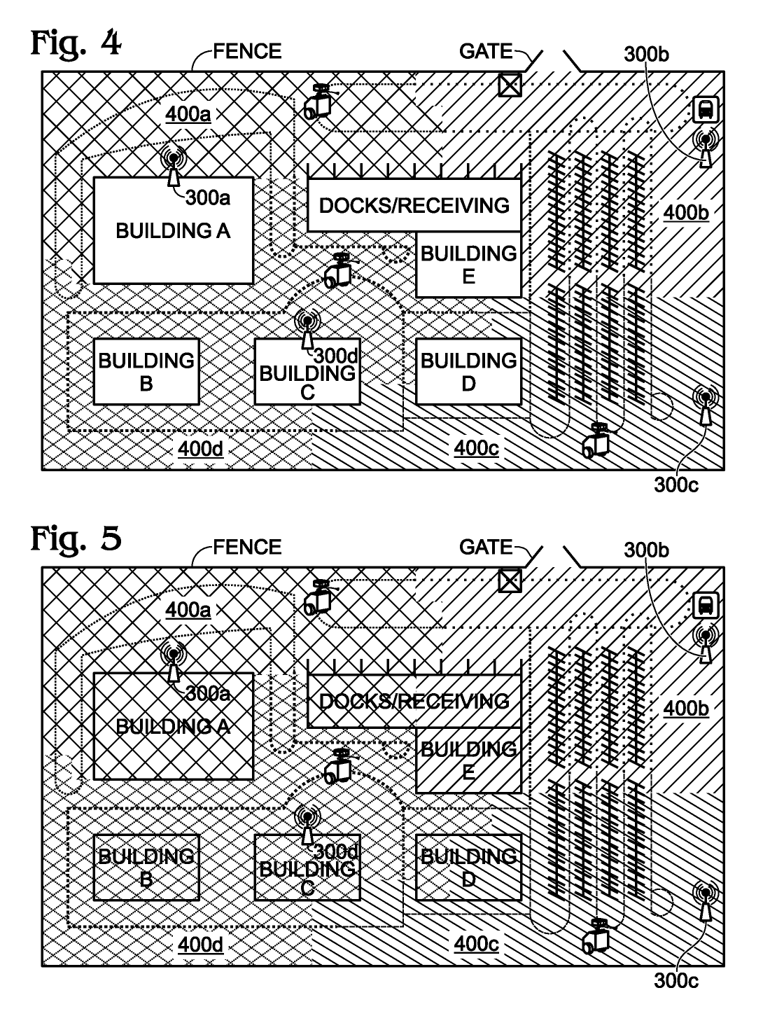

FIG. 4 is a plan view depicting a second exemplary patrolled region. Instead of mapping individual points along a pre-planned route, entire areas of a location can be mapped to tell the autonomous robotic device (or multiple autonomous robotic devices) as to which wireless network nodes it should be communicating with at any given position within the patrol location. Wireless APs 300a through 300d are respectively assigned to sub-regions 400a through 400d.

FIG. 5 is a plan view depicting a third exemplary patrolled region. The mapping concept shown in FIG. 4 can be extended even further to cover the interiors of the buildings in the event that the autonomous robotic device is assigned patrol duties inside the buildings.

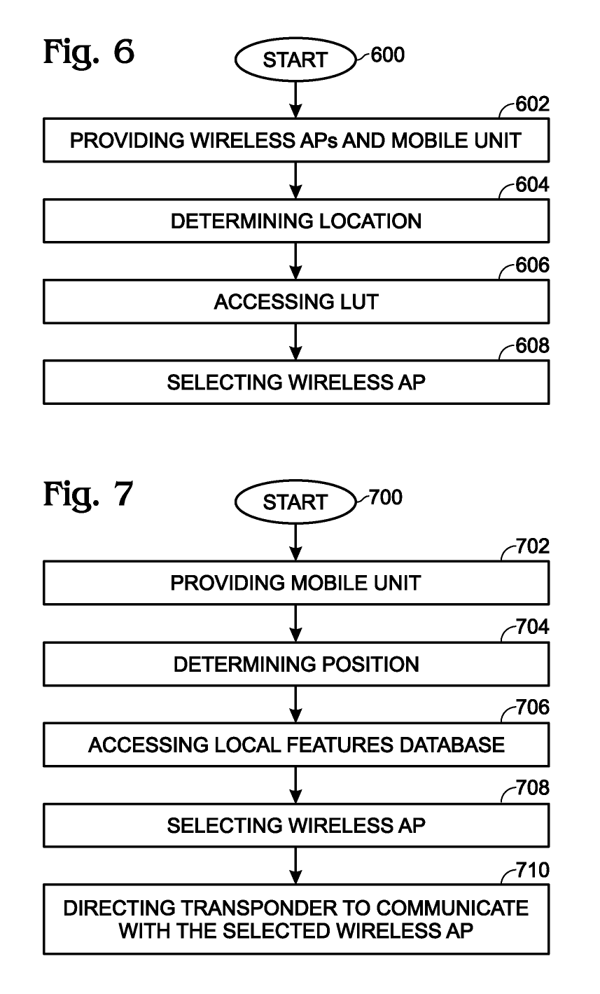

FIG. 6 is a flowchart illustrating a wireless access point selection method. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 600.

Step 602 provides a plurality of wireless access points and a mobile unit with a wireless transponder. In Step 604 the mobile unit determines its location. In Step 606 the mobile station accesses a LUT cross-referencing locations to corresponding wireless APs, and in response to accessing the LUT, the mobile unit selects a wireless AP in Step 608.

FIG. 7 is a flowchart illustrating a method for a mobile unit to select a wireless access point. The method begins at Step 700. Step 702 provides a mobile unit with a wireless transponder, a location determination device (e.g., a GPS receiver), a non-transitory memory, and a processor. A local features database is stored in the memory and cross-references a plurality of wireless APs to corresponding geographic locations. A wireless AP selection application is also stored in the memory and enabled as a sequence of processor executable instructions. In response to receiving location information from the location determination device, in Step 704 the wireless AP selection application determines the geographic position of the mobile unit. In Step 706 the wireless AP selection application accesses the local features database. In Step 708 the wireless AP selection application selects a wireless AP associated with the geographic position of the mobile unit, and in Step 710 the wireless AP selection application directs the transponder to communicate with the selected wireless AP. In one aspect, the transponder is capable of operating at a plurality of channels, as defined above, and in Step 710 the wireless AP selection application directs the transponder to operate at a channel associated with the selected wireless AP.

In one format Step 702 provides a local features database comprising an organization of information that divides a geographic region into sub-regions, with a corresponding wireless AP assigned to each sub-region. In a simple variation, each sub-region is assigned to the closest wireless AP. In another aspect, each sub-region is assigned to a corresponding wireless AP on the basis of wireless AP figure of merit, such as the transmitter power of the wireless AP, signal strength of the received wireless AP signal, bit error rate, signal-to-noise ratio, latency, the directionality of the wireless AP's antenna, or the directionality of the mobile unit's transponder antenna.

In another aspect, the local features database comprises an organization of information that includes communications obstacles located in the geographic region, with wireless APs assigned to each sub-region on the basis minimizing the impact of the communications obstacles. In yet another aspect, the local features database assigns wireless APs to each sub-region on the basis of a known wireless AP enablement schedule.

In one variation Step 702 provides a local features database comprising information that at least one (e.g., a first) sub-region that is assigned a primary wireless AP and a secondary wireless AP. Then, the wireless AP selection application determines that the mobile unit is located in the first sub-region in Step 704, and in the event that communications with the primary wireless AP fail, selects the secondary wireless AP in Step 708.

A system and method have been provided for selecting a wireless AP. Examples have been presented to illustrate the invention. However, the invention is not limited to merely these examples. Although the invention has been presented in the context of autonomous navigation, it has wider application to other mobile wireless networks. Other variations and embodiments of the invention will occur to those skilled in the art.

We claim:

1. A method for a mobile unit to select a wireless access point, the method comprising:
providing a mobile unit with a wireless transponder, a location determination device, a non-transitory memory, a processor, a local features database stored in the memory cross-referencing a plurality of wireless access points (APs) to corresponding geographic locations, and a wireless AP selection application stored in the memory and enabled as a sequence of processor executable instructions;
in response to receiving location information from the location determination device, the wireless AP selection application determining the geographic position of the mobile unit;
the wireless AP selection application accessing the local features database;
the wireless AP selection application selecting a wireless AP associated with the geographic position of the mobile unit; and,
the wireless AP selection application directing the transponder to communicate with the selected wireless AP.

2. The method of claim 1 wherein providing the local features database includes the local features database dividing a geographic region into sub-regions, with a corresponding wireless AP assigned to each sub-region.

3. The method of claim 1 wherein providing the local features database includes the local features database dividing a geographic region into sub-regions, with each sub-region assigned to the closest wireless AP.

4. The method of claim 1 wherein providing the transponder includes providing a transponder capable of operating at a plurality of channels; and,
wherein the wireless AP selection application directing the transponder to communicate with the selected wireless AP includes the wireless AP selection application directing the transponder to operate at a channel associated with the selected wireless AP.

5. The method of claim 1 wherein providing the local features database includes the local features database dividing a geographic region into sub-regions, with each sub-region assigned to a corresponding wireless AP on the basis of wireless AP figure of merit.

6. The method of claim 5 wherein the received wireless AP figure of merit is dependent upon a condition selected from the group consisting of the transmitter power of the wireless AP, signal strength of the received wireless AP signal, bit error rate, signal-to-noise ratio, latency, the directionality of the wireless AP's antenna, and the directionality of the mobile unit's transponder antenna.

7. The method of claim 1 wherein providing the local features database includes the local features database comprising a geographic region including communications obstacles, divided into a plurality of sub-regions, with a wireless AP assigned to each sub-region on the basis of minimizing the impact of the first communications obstacle.

8. The method of claim 1 wherein providing the local features database includes the local features database dividing a geographic region into a plurality of sub-regions, with wireless APs assigned to each sub-region on the basis of a known wireless AP enablement schedule.

9. The method of claim 1 wherein providing the local features database includes the local features database dividing a geographic region into sub-regions, with a first sub-region assigned a corresponding primary wireless AP and a corresponding secondary wireless AP;
wherein the wireless AP selection application determining geographic position includes the wireless AP selection application determining that the mobile unit is located in the first sub-region; and,
wherein the wireless AP selection application selecting the wireless AP includes, in the event that communications with the primary wireless AP fail, the wireless AP selection application selecting the secondary wireless AP.

10. The method of claim 1 wherein providing the location determination device includes providing a global positioning satellite (GPS) receiver.

11. A mobile unit system for selecting a wireless access point, the system comprising:
a wireless transponder;
a location determination device;
a non-transitory memory;
a processor;
a local features database stored in the memory cross-referencing a plurality of wireless access points (APs) to corresponding geographic locations; and,
a wireless AP selection application stored in the memory and enabled as a sequence of processor executable instructions, the wireless AP selection application determining the geographic position of the mobile unit in response to receiving location information from the location determination device, accessing the local features database, selecting a wireless AP associated with the geographic position of the mobile unit, and directing the transponder to communicate with the selected wireless AP.

12. The system of claim 11 wherein the local features database divides a geographic region into sub-regions, with a corresponding wireless AP assigned to each sub-region.

13. The system of claim 11 wherein the local features database divides a geographic region into sub-regions, with each sub-region assigned to the closest wireless AP.

14. The system of claim 11 wherein the transponder is capable of operating at a plurality of channels; and,
wherein the wireless AP selection application directs the transponder to operate at a channel associated with the selected wireless AP.

15. The system of claim 11 wherein the local features database divides a geographic region into sub-regions, with each sub-region assigned to a corresponding wireless AP on the basis of wireless AP figure of merit.

16. The system of claim 15 wherein the received wireless AP figure of merit is dependent upon a condition selected from the group consisting of the transmitter power of the wireless AP, signal strength of the received wireless AP signal, bit error rate, signal-to-noise ratio, latency, the directionality of the wireless AP's antenna, and the directionality of the mobile unit's transponder antenna.

17. The system of claim 11 wherein the local features database divides a geographic region including communications obstacles, into a plurality of sub-regions, with a wireless AP assigned to each sub-region on the basis minimizing the impact of the first communications obstacle.

18. The system of claim 11 wherein the local features database divides a geographic region into a plurality of sub-regions, with wireless APs assigned to each sub-region on the basis of a known wireless AP enablement schedule.

19. The system of claim 11 wherein the local features database divides a geographic region into sub-regions, with a first sub-region assigned a corresponding primary wireless AP and a corresponding secondary wireless AP; and,
wherein the wireless AP selection application determines that the mobile unit is located in the first sub-region, and in the event that communications with the primary wireless AP fail, selects the secondary wireless AP.

20. The system of claim 11 wherein the location determination device is a global positioning satellite (GPS) receiver.

21. A wireless access point selection method comprising;
providing a plurality of wireless access points (APs) and a mobile unit with a wireless transponder;
the mobile unit determining its location;
the mobile station accessing a look-up-table (LUT) cross-referencing locations to corresponding wireless APs; and,
in response to accessing the LUT, the mobile unit selecting a wireless AP.
